(19) United States
(12) Patent Application Publication
(10) Pub. No.: US 2009/0022565 A1
(43) Pub. Date: Jan. 22, 2009

(54) Method of Driving a T-Nut Into a Pre-Drilled Hole in a Work Piece, an Apparatus For Carrying Out the Method, a T-Nut Strip and a T-Nut

(75) Inventor: John Erik Foxby, Bedsted (DK)

Correspondence Address: KNOBBE MARTENS OLSON & BEAR LLP, 2040 MAIN STREET, FOURTEENTH FLOOR, IRVINE, CA, 92614, US

(73) Assignee: UNIMERCO A/S, Sunds (DK)

(21) Appl. No.: 11/722,168

(22) PCT Filed: Dec. 21, 2005
(86) PCT No.: PCT/DK2005/000809

§ 371 Date: Feb. 6, 2008

(30) Foreign Application Priority Data
Dec. 21, 2004 (DK) PA 2004 01983

(51) Int. Cl. F16B 37/04; B23P 19/00; F16B 27/00; F16B 39/00

(52) U.S. Cl. 411/179; 29/798; 411/84; 411/81

(57) ABSTRACT

The invention relates to a T-nut insertion method and an apparatus of the type for driving T-nuts into e.g. a wooden work piece with predrilled holes. A T-nut strip with improved and controllable rupture characteristics is also disclosed. Finally, embodiments of T-nuts with T-nut strip cutting protrusions or shapes are also disclosed. By applying the method according to the invention, a safe and precise insertion of T-nuts is obtained without the risk of T-nuts accidentally being driven from the apparatus and without the risk of the T-nuts being driven into the work piece at locations beside the predrilled holes.

### FIELD OF THE INVENTION

The invention relates to insertion of Tee-nuts also referred to as T-nuts, into a work piece with predrilled holes. The invention also relates to an apparatus for carrying out the method. Furthermore, the invention relates to a fastener strip for T-nuts and to T-nuts.

### BACKGROUND OF THE INVENTION

Threaded fastening devices known as T-nuts are widely used in the furniture manufacturing industry and other industries. Such T-nuts are commonly manufactured of sheet metal and incorporate a threaded sleeve or barrel, and an integral flange and spikes, which spikes after insertion are embedded in a work piece around the predrilled hole. T-nuts are used, for example, in the construction and connection of various furniture items.

Machinery for insertion of T-nuts is often all operated by compressed air, powering a power cylinder that is connected to an insertion plunger. Almost all such machines employ some kind of magazine or T-nut supply system for supplying T-nuts to a plunger.

When such machinery is stationary, the machinery is usually operated by an operator having to stand at the machine, holding the work piece in position. The operator locates the point for insertion of the T-nut, places the point for insertion of the T-nut (the predrilled hole) beneath the position of the plunger and then activates the machine. The activation is usually done by means of a pedal operated by a foot. Obviously, variations are possible on such machinery, but the machinery described is the system most widely used. Most such machinery operate on a downward insertion cycle. The T-nut and plunger are located above the work piece. The work piece is supported on a rest. Upon activation, the plunger descends downwards, picks up a T-nut and forces it into the work piece.

However, variations exist in which an upward insertion system is used. The plunger and T-nut are located below the work piece, and the support is located above the plunger.

U.S. Pat. No. 5,606,794 discloses a machine for downward insertion of a T-nut into a work piece of the type having a T-nut supplying source and a power cylinder assembly. The power cylinder assembly is characterised in the way it also applies a certain adjustable mass on the piston. The piston ends in a plunger that is adapted to engage and drive a T-nut into a work piece upon activation. It is described that by providing a mass on the piston that is accelerated by gravity and air pressure during a downward stroke, the T-nut is hereby driven into the work piece with a very low shock effect and with a higher precision than commonly known equipment.

Insertion systems that are capable of being operated handheld and are capable of inserting T-nuts in a predrilled hole of a surface of a work piece are also available. Such apparatuses are commonly called T-nut striking tools. T-nut striking tools comprise a striking tool including the power cylinder and the plunger. A magazine for holding and supplying the T-nuts is normally attached to the striking tool.

Handheld insertion systems are commonly used in situations where the work pieces are so large that the operator cannot handle the work pieces as described with reference to stationary machinery, or in situations where the process is not fully automated due to other various reasons. Handheld systems are also provided where stationary systems, as described, are not available.

Relating to both stationary machinery and handheld machinery, for many purposes it has been found appropriate to place the T-nuts in line on a strip or a belt in order for the supply of T-nuts to be more reliable compared to a supply of single T-nuts individually. The supply of single T-nuts has a tendency of jamming or causing a false insertion of the supplied T-nut due to a non-precise supply of T-nuts.

U.S. Pat. No. 6,209,722 describes a strip for the supply of T-nut fasteners. There is provided a strip made of a flexible material connecting the fasteners in sequential relationship along the strip. The fasteners are connected to the strip by bonding. The strip is breakable between adjacent fasteners when such fasteners are inserted into a work piece.

It has been found that both the stationary systems as well as the handheld systems have disadvantages in relation to safety and/or in relation to precision. It has also been found that prior art strips may incur problems during insertion of the T-nuts, and which adds to the other disadvantages of the prior art systems, for which these T-nut strips are used.

### SUMMARY OF THE INVENTION

It may be an object of the present invention to provide a method of and an apparatus for insertion of a T-nut in a surface of a work piece with predrilled holes, and which insertion is simple, safe, reliable and provides a precise insertion of the T-nut. It may additionally or alternatively be an object of the invention to provide a strip for connecting a plurality of T-nuts, and where said strip during insertion of a T-nut does not impede a precise insertion of the T-nut.

The firstly mentioned object of the invention is achieved by a method of driving a T-nut into a predrilled hole in a work piece by means of an apparatus comprising
driving means for driving the T-nut into the work piece
means for disabling activation of the driving means and
means for enabling activation of the driving means
   the method comprising the following steps of
a) supplying a T-nut to a position in the apparatus, prior to inserting the T-nut in the predrilled hole in the work piece,
b) searching and selecting a predrilled hole in the work piece, during which searching and selection activation of the driving means is disabled,
c) partly inserting the T-nut into the predrilled hole having been searched and selected, subsequent to which partly insertion activation of the driving means is enabled,
d) fully inserting the T-nut into the predrilled hole in the work piece by activation of the driving means.

By initially only partly inserting the T-nut and subsequently fully inserting the T-nut, a two-step insertion of the T-nut into the work piece is obtained. A method is thus provided with the effect that the method renders the tool safe to operate, and the method furthermore provides a very precise and reliable insertion of the T-nuts in the predrilled holes of the work piece.

The effects mentioned are due to one or more of the following facts: Because the T-nut, before full insertion, is only partly inserted in the predrilled hole, the T-nut will by certain be at least partly inserted in the predrilled hole, when the driving means is activated. Because the driving means only is capable of being activated when the T-nut is partly inserted, both the safety is improved towards accidental driving of the T-nut, when not inserted in the predrilled hole, and the precision is improved towards accidental insertion of the T-nut in a position beside the predrilled hole.

According to an aspect of the method according to the invention, the apparatus further comprises
a striking tool comprising automated means for driving a driving means intended for driving the T-nut into the predrilled hole
a magazine for a containing a number of T-nuts intended for being displaced from the magazine to the driving means,
   and the method step a) further comprises the step of
supplying at least one T-nut from the magazine to the driving means, and at which striking tool a distant end of a barrel of the T-nut extends outside a plane defined by an outermost extension of the striking tool.

By having a distant end of the barrel of the T-nut extending outside an outermost extension of the striking tool, the distant end of the barrel of the T-nut may be used for searching and selecting a predrilled hole for insertion of the T-nut. The improved method is provided for a fast, a safe and a precise insertion of T-nuts. There is no need for individual elements of the striking tool used for searching and/or selecting the predrilled hole.

According to further aspects of the method according to the invention, the apparatus further comprises
guiding means such as a longitudinal bearing for guiding the driving means in relation to surface of the work piece,
sliding means for sliding the apparatus along a sliding level of a surface of the wok piece, and the method step b) further comprising the following steps of
positioning the striking tool with the T-nut towards the surface by performing a guided displacement of the striking tool with the T-nut towards the surface of the work piece, or vice versa, to a first position and maintaining the position at the surface of the work piece, and
sliding the distant end of a barrel of the T-nut along the surface of the work piece, or vice versa, and hereby initially searching and subsequently selecting the predrilled hole.

The improved method is provided for a fast and safe and precise and reliable insertion of T-nuts. The first position is a position where the distant end of the barrel of the T-nut is in abutment with the surface of the work piece. The sliding of the distant end of the barrel along the surface of the work piece is performed for searching a predrilled hole in the surface of the work piece. When a predrilled hole is found, the distant end of the barrel of the T-nut will plunge into the predrilled hole, and the T-nut will hereafter be partly inserted in the predrilled hole.

According to a particular aspect of the method according to the invention the method step c) further comprises the following steps of
partly inserting the T-nut in the predrilled hole by pushing the striking tool and thereby the T-nut from a first position into the predrilled hole in the surface or by pushing the predrilled hole onto the T-nut and hereby guiding the T-nut to a second position, and
enabling activation of the driving means for driving the T-nut into the predrilled hole of the work piece when the T-nut has been partly inserted into the predrilled hole to the second position.

The effects of the improved method are provided for a safe, precise and reliable insertion of T-nuts. The second position is a position where the distant end of the barrel of the T-nut is partly inserted in the predrilled hole of the work piece. A precise positioning of the T-nut in relation to the predrilled hole is thereby obtained. The driving means may hereafter be activated. A safe insertion of the T-nut is obtained, when enabling of the driving means only is possible, when the distant end of the barrel of the T-nut is partly inserted.

According to particular aspect of the method according to the invention, the method step d) further comprises the following steps of
fully inserting the T-nut from the second position into the predrilled hole of the work piece to a final position, and
activating a trigger of the striking tool, preferably by manually activating the trigger, thereby activating the driving means and driving the T-nut into the predrilled hole.

The effects of the improved method are provided for a safe, precise and reliable insertion of T-nuts. The fully insertion of the T-nut follows the step, where the T-nut is in the second position. A precise insertion of the T-nut in relation to the predrilled hole is thereby obtained. The driving means are still activated during the step between the partly insertion and the fully insertion of the T-nut. A reliable insertion of the T-nut is obtained, when enabling of the driving means is possible, also for fully insertion of the T-nut.

The invention also relates to an apparatus, and the one object of the invention is achieved by an apparatus for driving one or more T-nuts at a time into a work piece surface with one or more predrilled hole(s), the apparatus comprising
a striking tool for activating a driving means
a magazine for a plurality of T-nuts before being driven into the work piece
supply means for supplying the T-nuts from the magazine to the striking tool
driving means for driving the T-nut into the predrilled hole of the work piece
means for disabling the driving means to be activated and
means for enabling the driving means to be activated.
   wherein the supplying means is capable of displacing the T-nut to a position of the striking tool, where a barrel of the T-nut extends outside a boundary of the striking tool, and wherein the apparatus further comprises
guiding means for guiding the striking tool with the T-nut to a first position in relation to the work piece so as to bring the barrel of the T-nut at the first position substantially in level with a level for sliding the apparatus along the surface
sliding means for sliding the barrel of the T-nut in the first position and the apparatus along and in abutment with the surface of the work piece and,
the disabling means intended for disabling the driving means to be activated when the T-nut is in the first position
the guiding means being adapted for guiding the T-nut from the first position into a second position beyond a level of the sliding means,
the enabling means intended for enabling the driving means to be activated when the T-nut is in the second position.

An effect of an apparatus according to the above main embodiment of the invention is as described for the method according to the invention. The obtainable technical effects therefore are e.g. an improved apparatus for a fast, a safe, a precise and a reliable insertion of T-nuts.

In particular, when incorporating the disabling and enabling means with the magazine and the striking tool, a simple and compact apparatus is provided. Furthermore, disabling and enabling of the striking tool is directly related to the surface of the work piece and to the magazine, from where the T-nuts are supplied.

When, according to embodiments of the apparatus according to the invention, the guiding means is providing a guided displacement of the striking tool in relation to the magazine, a precise positioning of the striking tool is achieved in relation to the surface of the work piece.

According to particular embodiments of the invention the sliding means comprises at least one of the following sliding elements: a roller ball, a roller pin, a wheel, a plane surface or a sliding rail. The sliding means are intended for easy sliding of the apparatus along the surface of the work piece, however, without scratching the surface of the work piece.

According to particular embodiments of the invention, the enabling means for enabling activation of the driving means, when the T-nut is in the second position, i.e. is partly inserted, is provided by at least one of the following means: a safety switch or a safety valve. The switch or valve may be of an electrical switch or a pneumatic valve.

According to particular embodiments of the invention, the apparatus is being displaced in relation to the surface of the work piece, and the surface of the work piece is placed in a substantially fixed position. Such embodiment is typically when the apparatus according to the invention is intended for being operated as lightweight handheld machinery.

According to particular embodiments of the invention the surface of the work piece is displaced in relation to the apparatus and the apparatus is placed in a substantially fixed position. Such embodiment is typically when the apparatus according to the invention is intended for being operated as large stationary machinery.

The invention also relates to a strip for connecting a plurality of T-nuts. The T-nuts are of the type having a barrel and having flanges extending from the barrel. The strip is provided for connecting the plurality of T-nuts in a sequential relationship with the flange of one T-nut intended for neighbouring the flange of another T-nut.

The strip is having a longitudinal direction intended for extending substantially parallel with the flanges of the T-nuts and extending along the sequential relationship of the T-nuts. The strip is having a transverse direction intended for extending substantially perpendicular to the flanges of the T-nuts. Along one extension, where the strip is intended for passing from a flange of one T-nut to a flange of another neighbouring T-nut, the strip is exhibiting a decreased strength in the transverse direction in comparison with a strength in the transverse direction along another extension, where the strip is intended for passing along a flange of only one T-nut.

An effect of providing a strip having a decreased strength in the transverse direction is that the strip has a predetermined decreased tensile strength providing a more efficient and safer rupture of the strip. Rupture of the strip is necessary when one T-nut, intended for being inserted next into the work piece, is to be singled out from the remainder of T-nuts not yet intended for insertion.

Because the T-nut, when being driven by the driving means, is singled out from the remaining T-nuts carried on the strip, the part of the strip carrying the remaining T-nuts does not affect the precision of insertion of the T-nut having been singled out. The effect of a more efficient and safer rupture of the strip is increased, when the strip is exhibiting a decreased strength along one extension, where the strip is intended for passing from a flange of one T-nut to a flange of another neighbouring T-nut.

According to embodiments of the strip according to the invention, the decreased strength in the transverse direction is a provided as a decreased tensile strength.

According to embodiments of the strip according to the invention, the decreased strength in the transverse direction is provided by perforations running across the strip in a sideways direction, at least in sideways directions along an extension, where the strip is intended for passing from a flange of one T-nut to a flange of another neighbouring T-nut provided in the sequential relationship of T-nuts along the strip.

According to embodiments of the strip according to the invention, the decreased strength in the transverse direction is provided by the material having anisotropy material characteristics in a sideways direction in comparison with more isotropy material characteristics in the longitudinal direction, at least in sideways directions along an extension, where the strip is intended for passing from a flange of one T-nut to a flange of another neighbouring T-nut provided in the sequential relationship of T-nuts along the strip.

The invention also relates to a T-nut. According to embodiments of the invention the T-nut is of a type having a flange extending from a barrel, and wherein said flange is provided with dedicated means in the form of protrusions intended for rupturing a strip used for connecting a plurality of T-nuts in a sequential relationship along said strip.

One possible technical effect of providing the T-nut with dedicated means for rupturing the strip is using less effort for rupturing the strip compared to other means only, such as a cutting knife, for rupturing the strip.

According to one specific embodiments of the T-nut according to the invention, at least one of the flange ends is provided with at least one protrusion extending substantially outwards from the flange and along a plane parallel with an extension of the flange.

According to another specific embodiment of the T-nut according to the invention, at least one of the flange ends is provided with at least one protrusion extending substantially outwards from the flange and obliquely to a plane parallel with an extension of the flange.

According to specific embodiments of the T-nut according to the invention, at least one of the flange ends has an extension forming an angle greater than 0° in relation to a transverse direction in a plane parallel with an extension of the flange.

### BRIEF DESCRIPTION OF THE DRAWINGS

The invention will hereafter be described with reference to the drawings, where

FIGS. 1A and 1B are a cross-sectional view and a photograph, respectively, of a preferred embodiment of an apparatus according to the invention,

FIGS. 2A and 2B are a close-up cross-sectional view and a close-up photograph, respectively, of the preferred embodiment of the apparatus having a T-nut supplied,

FIGS. 3A and 3B are a plane view photograph and a close-up photograph, where a T-nut has been supplied and is in a first position abutting a work piece surface,

FIGS. 4A and 4B are a cross-sectional view and a close-up photograph, where a T-nut is in a second position partly inserted into a predrilled hole,

FIGS. 5A and 5B are a cross-sectional view and a close-up photograph, where a T-nut is in a final position fully inserted in the predrilled hole,

FIG. 6 is a close-up photograph of one T-nut being fully inserted in the predrilled hole and of the apparatus being supplied another T-nut after having inserted the one T-nut,

FIG. 7 is a photograph showing a first embodiment and a second embodiment of a T-nut strip according to the invention and with a plurality of T-nuts attached to the strip,

FIG. 8 is one close-up photograph showing the first embodiment and the second embodiment of a T-nut strip according to the invention and with T-nuts attached,

FIG. 9 is another close-up photograph showing the first embodiment and the second embodiment of a T-nut strip according to the invention and with T-nuts attached, and

FIGS. 10, 11 and 12 are sketches showing different embodiments of T-nuts having specially designed flanges intended for assisting in rupturing a strip connecting the T-nuts.

### DETAILED DESCRIPTION OF THE INVENTION

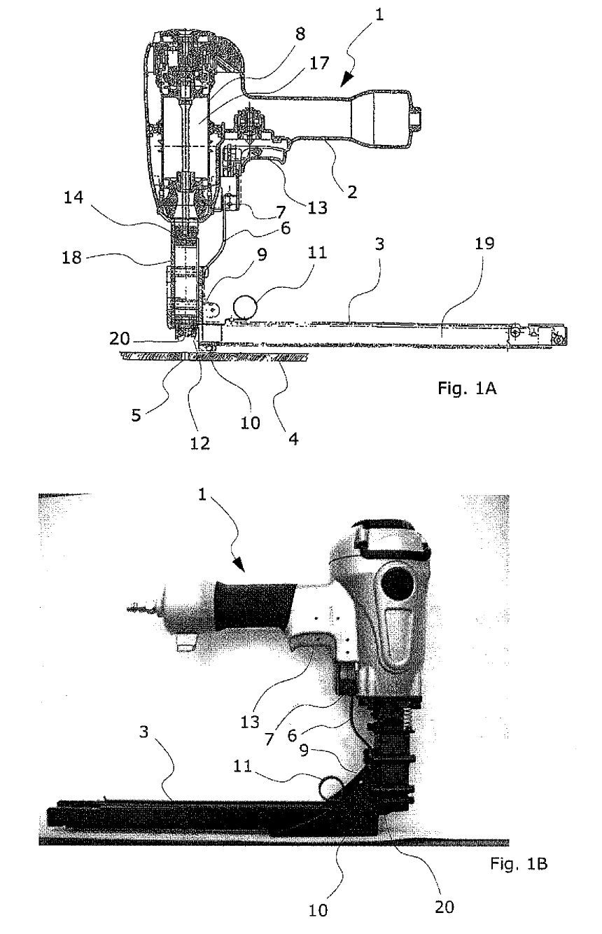

FIG. 1A and FIG. 1B show a T-nut tool 1 with a striking tool 2 and a magazine 3. A work piece 4 is shown being provided with a predrilled hole 5. A lever 6 of the striking tool 2 is intended for co-operating with a combined disabling/enabling means 7. Comprised in the striking tool 2, a striking means 8 is provided comprising a pneumatic piston 17 and a plunger 14. Guiding means 9 is provided for enabling a guided displacement of the striking tool 2 in relation to the magazine 3.

The magazine 3 is intended for containing a plurality of T-nuts to be successively supplied to the driving means and to be inserted into predrilled holes of the work piece. The magazine 3 is preferably provided with a spring member 11 for successively displacing the T-nuts towards the driving means.

Sliding means 10 is provided for enabling a sliding displacement of the magazine 3 and thus of the T-nut tool as such along a surface of the work piece. The spring member 11 is provided for a sequential supply of T-nuts from the magazine 3. A cutting knife 12, alternatively just a cutting punch, for cutting a strip (not shown) connecting a plurality of T-nuts in the magazine 3 is positioned between the striking tool 2 and the magazine 3. A manually operable trigger 13 is provided for activating the striking means 8 for thereby driving the T-nuts (not shown) into the work piece 4, preferably into the predrilled holes 5 of the work piece 4.

The striking means 8 comprises a pneumatic piston 17 co-operating with a plunger 14 for striking a driving means 20 for driving the T-nuts into the work piece 4 provided with the predrilled hole 5. In the embodiment shown, the plunger 14 and the driving means 20 are shown as being separate elements. In an alternative and preferred embodiment, the plunger and the driving means constitute an integrate element, i.e. the driving means 20 constitute the distant end of the plunger 14. Thus, in the elevated position of the plunger 14 as shown in the figure, the driving means 20, in the alternative and preferred embodiment, would also be positioned elevated, contrary to the lowered position of the driving means 20 shown in the figure. The striking means 8 is chosen among existing solutions for establishing a striking force to the plunger 14 for striking the driving means 20 for driving the T-nut into the predrilled hole by providing a pneumatic pressure to the pneumatic piston 17.

The magazine 3 is mutually connected to the striking tool 2 in such a manner as to provide a possible guided linear displacement, in the embodiment shown a vertical downward displacement, of the striking tool 2 relative to the magazine 3. The distance of displacement of the striking tool 2 relative to the magazine 3 may be less than 100 mm., preferably less than 50 mm. and most preferred less than 20 mm. In the embodiment shown the possible distance of displacement is less than 20 mm.

When the striking tool 2 is not displaced towards the work piece 4, the striking tool 2 and the magazine 3 will be in a position relative to each other as is shown on FIGS. 1A and 1B. The relative position between the striking tool 2 and the magazine 3 may be provided by mechanical means such as a spring (not shown) acting between the striking tool 2 and the magazine 3 as a resilient suspension, in the embodiment shown a vertical upward suspension, of the striking tool 2 relative to the magazine 3. The spring may e.g. be a compression spring positioned around the striking tool 2 at the position 18 on FIG. 1A. Because the magazine 3 is intended for sliding along the surface of the work piece 4, the relative position between the striking tool 2 and the magazine 3 is also a relative position between the striking tool 2 and the surface of the work piece 4.

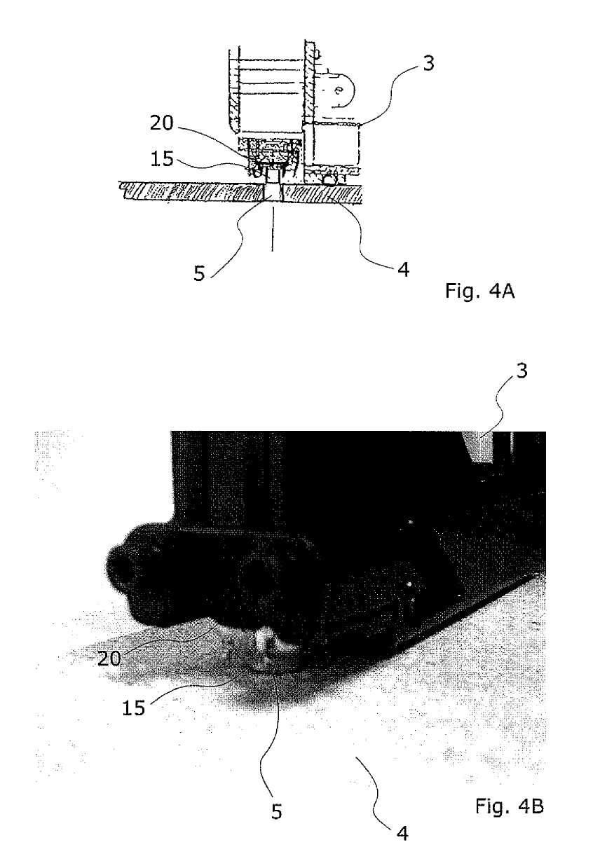

The lever 6 is capable of registering a mutual displacement between the striking tool 2 and the magazine 3, and thus between the striking tool 2 and the surface of the work piece 4. The lever 6 is attached to the magazine 3 and co-operates with the combined disabling/enabling means 7 of the striking tool 2. By a second position of the T-nut (not shown in FIG. 1A and FIG. 1B) as shown in FIG. 4A and FIG. 4B, where the T-nut is partly inserted into the predrilled hole 5, the lever 6 is displaced upwards a certain pre-defined distance in relation to the combined disabling/enabling means 7. The upwards displacement of the lever 6 enables the striking means 18 to be activated by the trigger 13.

The register of an upwards displacement of the lever 6 along a certain pre-defined distance may be registered by a mechanical switch, an electronic switch or a pneumatic valve. The choice of registering means depends on the accuracy needed of the means for registering the upwards displacement of the lever 6, and depends on the operating energy-facilities, i.e. electric or pneumatic, at hand, when designing the apparatus. The choice of registering means also depends on the kind of striking tool 1, when operating the apparatus, i.e. is the apparatus intended for electric operation or for pneumatic operation.

The magazine 3 comprises a compartment 19 for containing a number of T-nuts. In the embodiment shown, the T-nuts are supplied by a coil spring 11 displacing the T-nuts towards the driving means 20 of the striking tool 2. As mentioned, supply of T-nuts is provided by the coil spring 11, but the supply may also be provided by other means such as a helical spring inside the compartment 19 or a pneumatic piston displacing the T-nuts towards the driving means 20. In the embodiment shown, the T-nuts (not shown) are placed in a sequential relationship on a strip (not shown) connecting the T-nuts within the magazine 3.

In other embodiments, the supply of T-nuts may be provided in the magazine 3 in a sequential relationship without a strip connecting the T-nuts. The supply of T-nuts may even be provided from a bulk of T-nuts. This may be the case in other embodiments of the apparatus, where the T-nut tool is fixed, e.g. where the T-nut tool as described is fixed to a stationary machine, or where the T-nut tool itself constitutes a stationary machine with a support for positioning of the work piece, and where it is the work piece that is displaced in relation to the T-nut tool, when T-nuts are to be inserted into the work piece, in stead of the T-nut tool being handheld and being displaced in relation to the work piece.

The driving means 20, is provided alongside a cutting knife 12, alternatively just a cutting punch, positioned alongside the driving means 20 for cutting the strip connecting the T-nuts in the magazine 3. It is necessary to release and single out the T-nut to be inserted next in relation to the possible remainder of T-nuts in the magazine 3. In the embodiment shown, the knife 12 or the punch cuts the strip as the driving means 20 is displaced towards the magazine 3. The outmost T-nut, initially having been supplied to the driving means 20, is hereby released from the remainder of T-nuts.

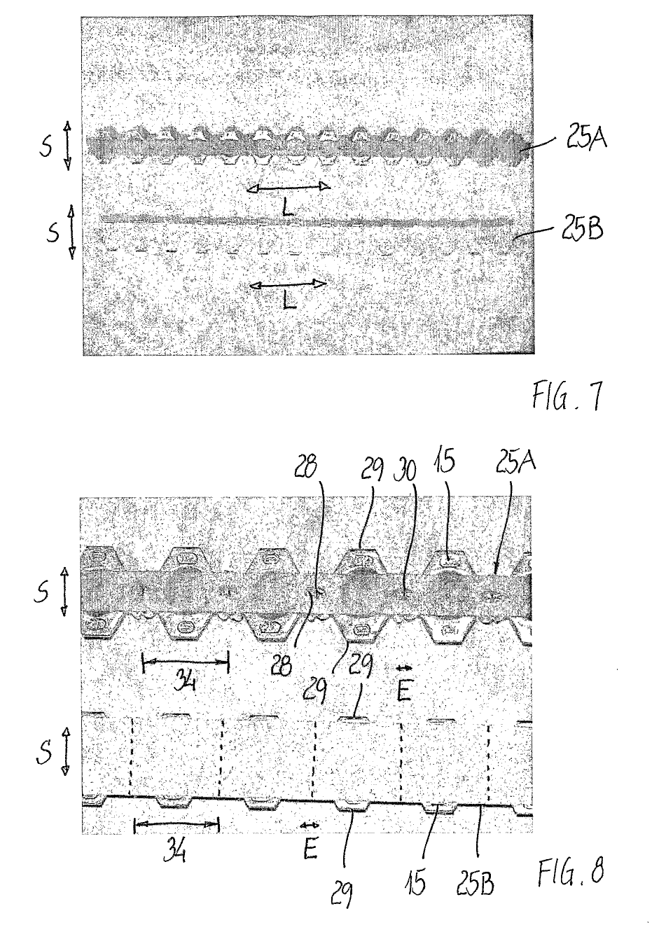

When using specially designed T-nuts (not shown, see FIG. 10-12) and/or when using a specially designed strip (not shown, see FIG. 7-9) the knife 12 or punch may be established as a counterpart co-operating with a protrusion comprised in the flange end of the T-nut itself rather than only the cutting knife or cutting punch as such being used when rupturing the strip.

The knife 12 may have a knife counterpart such as a cutting land (not shown) positioned on a foremost edge of the magazine 3. The driving means 20 may be magnetised by permanent magnets or by inductive means in order to hold the T-nut in the outmost position at the driving means 20, subsequent to the T-nut having been supplied from the magazine 3 and having been positioned within the driving means 20, and before the T-nut is to be inserted into the work piece. The driving means 20 may alternatively or additionally comprise mechanical T-nut gripping means, which gripping means are released before driving the T-nut into the predrilled hole of the work piece, or which gripping means are released subsequent to the T-nut having been fully inserted into the work piece, and when the driving means 20 is retracted after full insertion of the T-nut.

After the strip has been cut or at least ruptured, the plunger 14 will, upon activation by the trigger 13, be forced, in the embodiment shown be forced downward, by the pneumatic pressure in the pneumatic cylinder 17 and towards the driving means 20. When a T-nut is supplied from the magazine 3 and is positioned within the driving means 20, the plunger will, upon activation, force the driving means 20 and thus the T-nut into the predrilled hole 5 of the work piece.

In the embodiment shown, the guiding means 9 is a post jig permitting a guided linear displacement of the striking tool 2 and the magazine 3 relative to each other. The end position of the guiding means may be adjustable in relation to the actual type of T-nut used and/or adjustable with respect to any safety regulations. Depending on the end position of the guiding means, the attachment of the lever 6 is also adjusted.

In the embodiment shown, the sliding means 10 is a sliding surface such as a nylon plate, possibly being provided with a roller ball, incorporated in a bottom surface of the magazine 3, which bottom surface is facing the surface of work piece 4 when operating the T-nut tool. Alternatively, the sliding means may a number of roller balls or roller pins. Even more in the alternative, the sliding means may be a kind of one or more small wheels or even just one or more sliding rails mounted on or integrated as part of the magazine bottom surface facing the work piece.

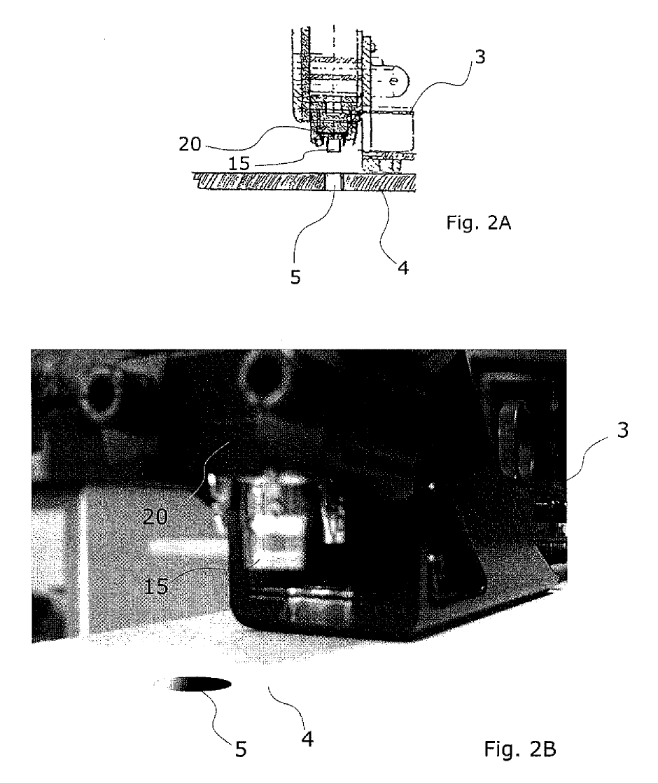

FIG. 2A and FIG. 2B show the striking tool head, i.e. the driving means 20, when the T-nut 15 has just been supplied from the magazine 3 and is positioned within the driving means 20.

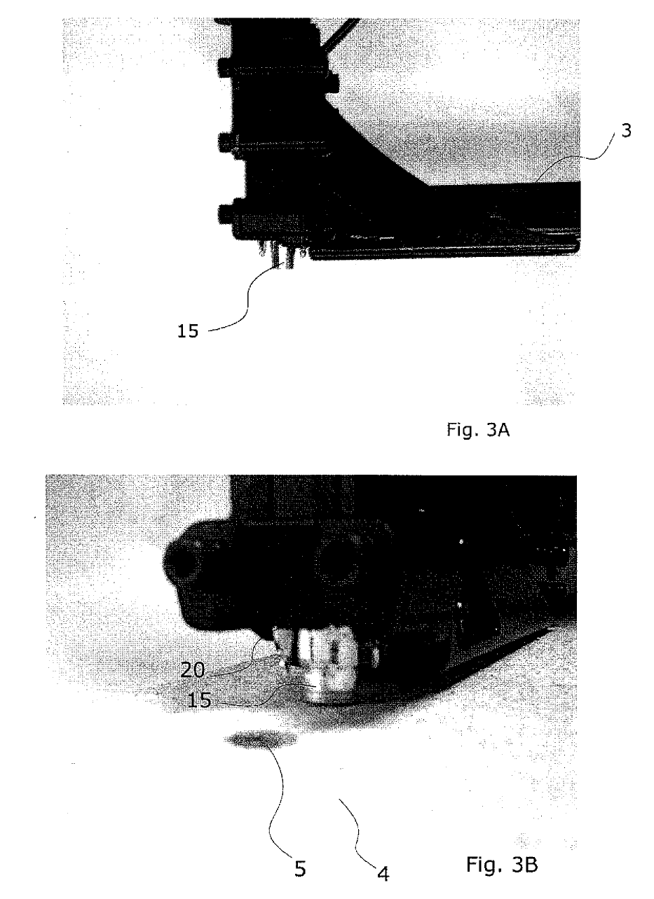

FIG. 3A and FIG. 3B show a T-nut in a first position. The striking tool 2 with the T-nut positioned within the driving means 20 has been guided, during displacement of the T-nut tool, towards the surface of the work piece 4. In this embodiment, a distant end of the barrel of the T-nut has been guided to a position beyond an outermost level of the surface of the sliding means 10. In this position, the T-nut tool 1 may be used for searching and selecting the predrilled hole 5 by moving the striking tool and thus the distant end of the barrel of the T-nut along the surface of the work piece until a predrilled hole is found and selected.

FIG. 4A and FIG. 4B show a T-nut in a second position. When the T-nut is in the second position, the predrilled hole in the work piece has been searched, the predrilled hole has been found and the predrilled hole has been selected as the predrilled hole to insert the T-nut. The driving means 20 with the T-nut is displaced further, in the embodiment shown displaced further downwards, towards the work piece until the T-nut is partly inserted in the predrilled hole.

In this embodiment of the invention and by the T-nut shown, the T-nut has been inserted to a level, where the barrel of the T-nut is partly inserted in the predrilled hole, and where spikes of the T-nut is abutting the surface of the work piece. Thus, only the barrel having a diameter corresponding to or being smaller than the diameter of the predrilled hole is partly inserted. The spikes, which are intended for being inserted into the work piece around the predrilled hole, have not yet been inserted.

When the T-nut is in the second position, where the barrel of the T-nut is partly inserted in the predrilled hole, the lever 6 is displaced a certain pre-determined distance. The certain pre-determined displacement of the lever 6 causes the combined disabling/enabling means 7 to enable activation of the striking means 8. Thus, when the T-nut is in the second position, the striking means 8 is ready for activation and for driving the T-nut into a fully inserted position into the work piece.

Upon obtaining the second position of the T-nut, and if the T-nut is connected to other T-nuts by means of a strip, the part of the strip, which is covering the T-nut to be inserted, is ruptured. Thus, said part of the strip formerly being part of the entire strip connecting the T-nut to be inserted to the remaining T-nuts within the magazine 3, now constitutes a singular strip part being detached from the remainder of the strip.

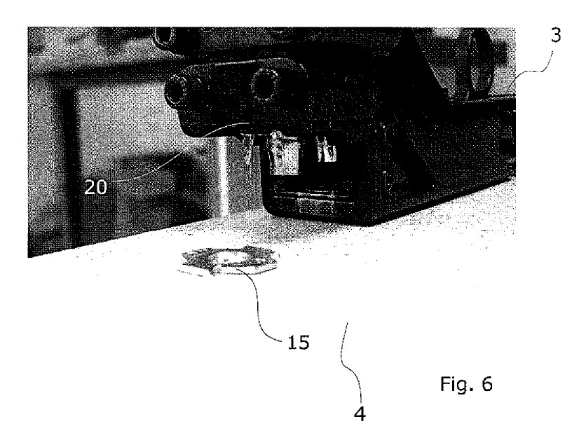

Upon activation of the trigger 13 of the striking tool 2, the pressurised air is driving the plunger towards the driving means 20 and thus towards the T-nut, whereby the T-nut is fully inserted into the work piece (not shown, see FIG. 6). When the T-nut is fully inserted, not only the barrel of the T-nut is fully inserted into the predrilled hole, also the spikes are fully inserted in the work piece around the predrilled hole. In alternative embodiments of T-nuts, no spikes are provided, the full insertion is obtained by only the barrel extending partly of fully through the predrilled hole in the work piece. The depth of full insertion into the work piece may be adjustable by means of a travelling distance of the plunger being adjustable. Alternatively, and preferably, the depth of insertion is merely limited to the flange of the T-nut coming into abutment with the surface of the work piece. The force, with which the full insertion occurs, is adjustable by means of the pneumatic pressure actuating the plunger.

When the T-nut tool, as described in the embodiment shown in the figures, is operated by the method as described, it provides a tool that is safe to operate, and which furthermore provides a very precise insertion of the T-nuts in the predrilled holes of the work piece. The safe and precise insertion of the T-nuts is obtained due to the fact that the T-nut, before being fully inserted, is partly inserted in the predrilled hole. Thus, the barrel of the T-nut will by certain plunge into the predrilled hole, and not beside the predrilled hole, when the driving means is activated and the T-nut is fully inserted into the work piece.

Because of the driving means only being capable of activation when the T-nut is partly inserted, both the safety towards accidental driving of the T-nut outside the predrilled hole, and the precision of driving the T-nut correctly into the predrilled hole, is hereby provided.

Because the T-nut together with the part of any strip covering the T-nut when being struck by the plunger or by any intermediate striking means, is singled out from the other T-nuts carried on the remainder of any strip, the remainder of any strip does not affect the precision of the full insertion, because the part of any strip covering the T-nut being struck is divided from the remainder of any strip covering the other T-nuts still in the magazine 3.

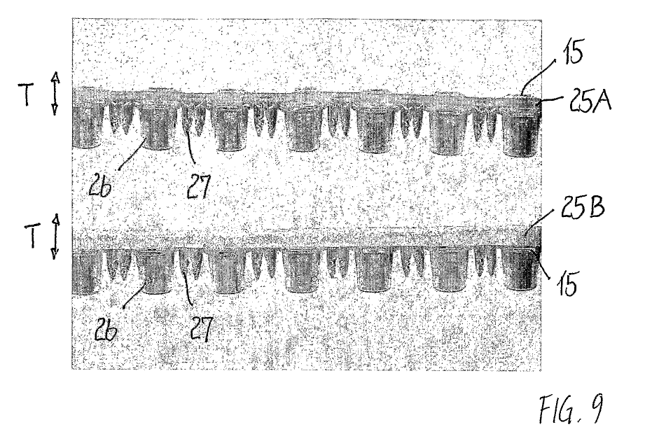

FIG. 7, FIG. 8 and FIG. 9 show two different embodiments of a T-nut strip according to the invention. The T-nut strips 25A and 25B are provided with a plurality of T-nuts 15, and the T-nuts are mutually connected by the flanges of the T-nuts being attached to the strips. Attachment to the strips take place by means of the strips having the one surface provided with glue facing the T-nuts. The T-nuts commonly comprises four spikes 27 and a polygonal flange having first and second flange ends 28, and a first flange side 29 and a second flange side 30, said second flange side 30 facing the spikes 27 and the barrel 26. The flange extends from the barrel 26 of the T-nut. In alternative embodiments, the number of spikes 27 is different and the flange may be circular or oval.

One technical feature common to the strips shown in the figures is that the material has a decreased tensile strength at least along an extension of the strip, where the strip passes from one T-nut to another T-nut. The tensile strength along at least the extension of the strip, where the strip passes from one T-nut to another T-nut is decreased compared to a remainder of the strip, where the strip passes from one flange end to another flange end of the one and same T-nut. The decreased strength of the strip, where the strip passes from one T-nut to another T-nut, is intended for being ruptured from e.g. a force from a cutting knife, a cutting punch or a cutting protrusion of a T-nut (see FIG. 10-12) forcing the material in a direction perpendicular to the longitudinal direction of the strip and perpendicular to an upper surface of the strip.

The upper embodiment, shown in the figures, of the strip exhibits a decreased tensile strength compared to the remainder of the strip material, in the transverse direction T (see FIG. 12) perpendicular to the longitudinal direction L of the strip and perpendicular to an upper surface of the strip, by means of a perforation 30 being made in the strip along the extension E of the strip where the strip passes from one T-nut to another T-nut. In the embodiment shown, only one relatively large perforation 30 is made. In alternative embodiments, more perhaps relatively smaller perforations may be made sideways S to the longitudinal extension L of the strip along the extension of the strip, where the strip passes from one T-nut to another T-nut.

The lower embodiment, shown in the figures, of the strip exhibits a decreased tensile strength compared to the remainder of the strip material in the transverse direction T (see FIG. 12) perpendicular to the longitudinal direction L of the strip 25B and perpendicular to an upper surface of the strip by means of an anisotropy (not shown) being applied to the material of the strip along the extension E (shown by dashed lines, which are not to be construed as perforations) of the strip where the strip passes from one T-nut to another T-nut. The anisotropy of the material, which the strip is made of, may be made by different means. The thickness or the width of the strip may be decreased along the extension E of the strip where the strip passes from one T-nut to another T-nut.

Alternatively, the material as such may be applied a decreased tensile strength by providing the material higher material strength along the part of the strip passing from one end of a flange to another end of a flange along only one T-nut, e.g. by embedding fibres or orientating fibres in a longitudinal direction, compared to the part of the strip, where the strip passes from one T-nut to another T-nut, e.g. by omitting fibres or by orientating fibres differently than longitudinally along the extension of the strip, where the strip passes from one T-nut to another T-nut.

Material fibre orientation being isotropy along the sntire extension of the strip, i.e. both the part of the strip extending from one T-nut to another T-nut and the part of the strip extending along only one T-nut must be prevented if the technical effect of easy and/or proper rupture is to be obtained of the strip along the extension of the strip where the strip passes from one T-nut to another T-nut.

The setting distance 34 of the T-nuts in the sequential relationship along the strip can be made quite precise during application of the strip to the T-nuts. By effort it is therefore possible to control the position of the perforations in order to place one line of perforation(s) between each set of T-nuts. Despite these efforts it may though be possible to place lines of perforation across the T-nut strip with a certain lower setting distance in the longitudinal direction than the setting distance of the T-nuts.

The setting distance of the lines of perforation may be smaller than the setting distance between the flange ends of the T-nuts. Thus, the setting distance may be any multiple of the setting distance of the T-nuts, e.g. the setting distance of the lines of perforation being ½ or ¼ or any other ratio of the setting distance of the T-nuts. Thus, lines of perforation may occur across the strip also along extension of the strip, where the strip extends fron one flange end to another flange end of only one T-nut.

According to any of the embodiments of a T-nut strip shown in FIG. 7-9, a T-nut strip with improved and controllable rupture characteristics is hereby achieved by applying certain material characteristics such as weakening of the material as such and/or by applying perforations or other means of dimensional weakening the strip.

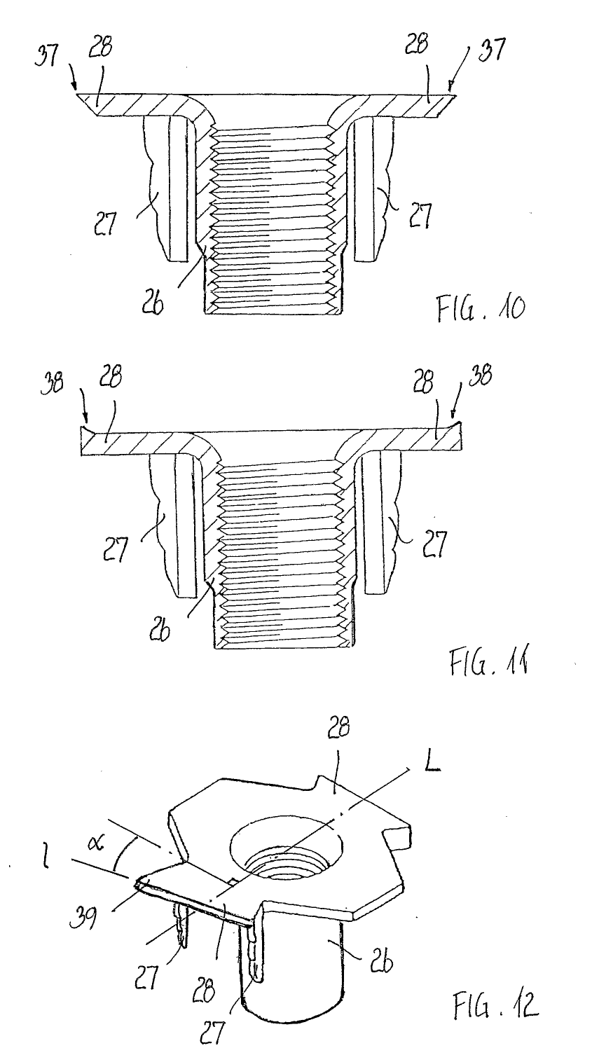

FIG. 10, FIG. 11 and FIG. 12 show different embodiments of a T-nut according to the invention. The T-nuts are provided with protrusions 37, 38, 39 extending from or along the flange ends 28. Normally only one type of the different T-nuts will be placed in sequential relationship along one strip for collecting the T-nuts (see FIG. 7-9).

FIG. 10 shows an embodiment of a T-nut according to the invention with a protrusion 37 extending outwards from each of the flange ends 28 in the plane of the flange. The protrusions 37 are manufactured as a downward tapering of the flange ends 28.

FIG. 11 shows an embodiment of a T-nut according to the invention with a protrusion 38 extending outwards from each the flange ends 28 obliquely to the plane of the flange. The protrusions 38 are manufactured as an upward burr of the flange ends 28.

FIG. 12 shows an embodiment of a T-nut according to the invention with a flange end 28 forming an angle α with a line I, said line I extending sideways to a longitudinal line L, and said angle being greater than 0°. The angularly designated flange end 28 creates a protrusion 39 lying in the plane of the flange. Preferably, the angle α is smaller 45° and most preferred the angle α is within the interval from 5° to 35°. By providing the flange ends 28 of the T-nut with an angle α, a distance d between the protrusion 39 of the flange end 28 of the T-nut in question and a flange end 28 of a neighbouring T-nut will be shorter than a distance D between a recessed part of the flange end 28 and the flange end of the neighbouring T-nut.

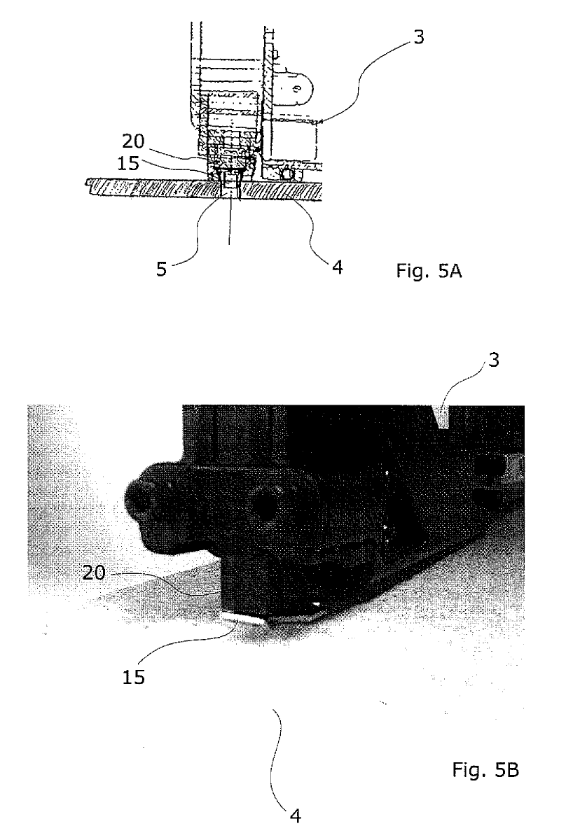

When the endmost T-nut to the left is displaced downwards by e.g. a T-nut driving means (see FIG. 1A-6) the strip 25 (shown by dashed line) will normally start rupturing at the lateral side of the strip, where the shorter distance d is present, and then rupture further along the flange end 28. This is mainly due to a tensile stress being higher at the side of the strip, where the shorter distance d is present, than at the side of the strip, where the larger distance D is present.

Such progressive rupture of the strip requires less force for rupturing the strip than a rupture at the same time along the entire transverse extension of the strip. It has also been found that providing the flange of the T-nut with the shape shown in FIG. 12 may significantly reduce a required sharpness of the flange end 28.

Rupture of the strip by providing the T-nuts with one or more protrusions according to either one of the embodiments shown in FIG. 10-12 by using the flange end 28 as cutting edge will reduce the force needed for rupturing the strip and will ensure a satisfactory rupture of the strip. The rupture of the strip may further be improved by applying a strip with anisotropy material characteristics and/or with perforations as described with reference to FIG. 7-9.

1. A method of driving a T-nut into a predrilled hole in a work piece by means of an apparatus comprising:
driving means for driving the T-nut into the work piece,
means for disabling activation of the driving means, and
means for enabling activation of the driving means,
the method comprising the following steps of:
a) supplying a T-nut to a position in the apparatus, prior to inserting the T-nut in the predrilled hole in the surface of the work piece,
b) searching and selecting a predrilled hole in the surface of the work piece, during which searching activation of the driving means is disabled,
c) partly inserting the T-nut into the predrilled hole having been searched and selected, subsequent to which partial insertion activation of the driving means is enabled, and
d) fully inserting the T-nut into the predrilled hole in the surface of the work piece by activation of the driving means.

2-20. (canceled)

22. The method according to claim 1, the apparatus further comprising:
a striking tool comprising automated means for driving the driving means intended for driving the T-nut into the predrilled hole;
a magazine for a containing a number of T-nuts intended for being displaced from the magazine to the driving means;
and the method step a) further comprising the step of:
supplying at least one T-nut from the magazine to the driving means, and at which driving means a barrel of the T-nut extends outside a plane defined by an outermost extension of the striking tool.

23. The method according to claim 1, the apparatus further comprising
guiding means such as a handle for guiding the apparatus with the T-nut,
sliding means for sliding the apparatus along a sliding level of the surface,
and the method step b) further comprising the following steps of:
positioning the striking tool with the T-nut towards the surface by performing a guided displacement of the striking tool with the T-nut towards the surface, or vice versa, to a first position and maintaining the first position at the surface, and
sliding the T-nut along the surface of the work piece, or vice versa, and hereby initially searching and subsequently selecting the predrilled hole.

24. The method according to claim 1, the method step c) further comprising the following steps of:
partly inserting the T-nut in the predrilled hole by displacing the striking tool, and thereby the T-nut, from a first position into the predrilled hole in the surface, or by displacing the predrilled hole onto the T-nut, and hereby guiding the T-nut into a second position,
enabling activation of the driving means for driving the T-nut into the predrilled hole of the work piece when the T-nut has been partly inserted into the predrilled hole to the second position.

25. The method according to 1, the method step d) further comprising the following steps of:
fully inserting the T-nut from the second position into the predrilled hole of the work piece to a final position,
activating a trigger of the striking, preferably by manually activating the trigger, thereby activating the driving means and driving the T-nut into the predrilled hole.

26. An apparatus for driving one or more T-nuts at a time into a work piece surface with one or more predrilled hole(s), the apparatus comprising:
a striking tool for activating a driving means for driving a T-nut into the work piece,
a magazine for a plurality of T-nuts before being driven into the work piece,
supply means for supplying the T-nuts from the magazine to the striking tool,
driving means for driving the T-nuts into the predrilled hole of the work piece,
means for disabling the driving means to be activated, and
means for enabling the driving means to be activated,
wherein the supply means is capable of displacing the T-nut to a position of the striking tool, where a barrel of the T-nut extends outside the striking tool, and wherein the apparatus further comprises:
sliding means for sliding the barrel of the T-nut in the first position and the apparatus along and in abutment with a surface of the work piece, and
guiding means being adapted for guiding the T-nut into a first position in relation to the sliding means so as to bring a distant end of the barrel part of the T-nut substantially in level with a level of the sliding means,
the disabling means being intended for disabling the driving means from being activated when the T-nut is in the first position,
the guiding means furthermore being adapted for guiding the T-nut from the first position into a second position in relation to the sliding means so as to bring the distant end of the T-nut barrel beyond the level of the sliding means, and
the enabling means being intended for enabling the driving means to be activated when the T-nut is in the second position.

27. An apparatus according to claim 26, wherein the guiding means is providing a guided displacement of the striking tool in relation to the magazine.

28. An apparatus according to claim 26, wherein the supply means comprises at least one of the following elastomeric elements: a coil spring, a helical spring, a pneumatic force-inducing element or a magnetic force-inducing element.

29. An apparatus according to claim 26, wherein the sliding means comprises at least one of the following sliding elements: at least one roller ball, at least one roller pin, at least one wheel, a plane surface or at least one sliding rail.

30. An apparatus according to claim 26, wherein the enabling means for enabling activation of the driving means, when the T-nut is in the second position, is provided by at least one of the following means: a mechanical switch, an electronic switch, a pneumatic valve or a hydraulic valve.

31. A strip for connecting a plurality of T-nuts, the T-nuts being of the type having a barrel part and flanges extending outwards from the barrel, and the strip being provided for connecting the plurality of T-nuts in a sequential relationship with the flange of one T-nut intended for opposing the flange of a neighbouring T-nut, the strip having a longitudinal direction intended for extending substantially parallel with the flanges of the T-nuts and intended for extending along the sequential relationship of the T-nuts and the strip having a transverse direction intended for extending substantially perpendicular to the flanges of the T-nuts, and the strip along one extension where the strip is intended for passing from a flange of one T-nut to a flange of a neighbouring T-nut, exhibiting a decreased strength in the transverse direction in comparison with a strength in the transverse direction along another extension where the strip is intended for passing along a flange of only one T-nut so that when the one extension of said strip, where the strip is intended for passing from a flange of one T-nut to a flange of a neighbouring T-nut is ruptured, the other extension of said strip, where the strip is intended for passing along a flange of only one T-nut, constitutes a singular strip part being detached from the remainder of the strip.

32. A strip according to claim 31, wherein the decreased strength in the transverse direction (T) along the extension (E) where the strip is intended for passing from a flange of one T-unit to a flange of a neighbouring T-nut, is a provided as a decreased tensile strength of the material, which the strip is made of.

33. A strip according to claim 31, wherein the decreased strength in the transverse direction (T) along the extension (E) where the strip is intended for passing from a flange of one T-nut to a flange of neighbouring T-nut, is provided by perforations (30) running across the strip in a sideways direction (S).

34. A strip according to claim 31, wherein the decreased strength in the transverse direction (T), at least where the strip is intended for passing from a flange of one T-nut to a flange of a neighbouring T-nut, is provided by the material, which the strip is made of, having anisotropy material characteristics in the transverse direction (T), at least along the extension (E) where the strip is intended for passing from a flange of one T-nut to a flange of another T-nut, in comparison with more isotropy material characteristics in the longitudinal direction (L) of the strip.

35. A T-nut of the type having a flange extending outwards from a barrel, and wherein the flange is provided with a dedicated means intended for rupturing a strip used for connecting a plurality of T-nuts in a sequential relationship along the strip.

36. A T-nut according to claim 35, wherein the flange is provided with at least one protrusion extending substantially outwards from the flange and along a plane parallel with an extension of the flange.

37. A T-nut according to claim 35, wherein the flange end is provided with an extension forming an angle greater than 0° in relation to a direction a plane parallel with an extension of the flange.
